(19) United States
(12) Patent Application Publication
(10) Pub. No.: US 2009/0284072 A1
(43) Pub. Date: Nov. 19, 2009

(54) METHOD AND SYSTEM FOR SELECTIVE ELECTRICAL BACKUP TO A MULTI-TENANT LOCATION

(76) Inventor: Joseph McNeill Everett, Cary, NC (US)

Correspondence Address: PASSE' INTELLECTUAL PROPERTY, LLC, 1717 BRASSFIELD RD., RALEIGH, NC, 27614, US

(21) Appl. No.: 12/465,291

(22) Filed: May 13, 2009

Related U.S. Application Data
(60) Provisional application No. 61/052,854, filed on May 13, 2008.

(51) Int. Cl. H02J 9/06

(52) U.S. Cl. 307/23

(57) ABSTRACT

The present invention provides a system for selectively providing backup electrical power to a multi tenant facility like an apartment building or a multi-tenant cell phone tower. By placing a remote disconnect on each of the tenants meters the tenant can be selectively attached or disconnected from a backup power system as desired.

This application claim priority over provisional application No. 61/052,854 filed on May 13, 2008 and is incorporated herein in its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a method and system for providing selective electrical backup power to a group of electrical grid customers. In particular the present invention relates to systems and methods for selectively attaching and detaching a group of electrical customers connected to an electrical grid and to an electrical backup power source.

2. Description of Related Art

Electrical power in most areas of the country is supplied by local power companies over an electrical grid. The distribution of AC electrical power over a power grid is often interrupted for a variety of intentional and unintentional reasons. For example the gird can be off line during equipment failure, line disconnection, load management conditions, servicing of the grid and the like.

A number of different methods and devices have been developed over the years to aid in the backup of electrical power in the event of a grid failure. There are several representative examples. U.S. Pat. No. 5,731,693 issued Mar. 24, 1998 to Furmanczyk describes a backup power supply for cellular communication stations. In U.S. Pat. No. 5,923,099 to Bilir issued Jul. 13, 1999 there is disclosed an intelligent backup power controller that performs “graceful” shutdowns of a processing system upon the loss of main AC power. In yet another backup system, U.S. Pat. No. 6,198,177 issued Mar. 6, 2001 to Mao and Thottuvelil there is described a power supply providing backup AC voltage and a method of operation and in U.S. Pat. No. 6,204,572 issued Mar. 20, 2001 to Liran there is described a power supply for providing instantaneous energy during electric utility outage.

It is clear that an electrical utility customer has many options and competing devices and methods when deciding to provide emergency AC backup to the electric grid. However, a serious problem arises when the customer is one of many in a multi tenant situation. Multitenant electrical customers refers to situations where a number of different customers are all in one location where each customer is served by his own electric meter and grid service. Examples of multi-tenants are apartment buildings, cell phone towers where all the local cell phone companies may share the same tower, and strip malls. In these situations each tenant wishing to backup their service needs their own back up unit or one that is shared with other tenants. Often times because of room requirements there is not enough room to provide space for multiple generators, especially for cell phone towers, not to mention, the waste of having the multiple units.

In cases where multiple tenants share a backup unit, the tenants are either on or off the unit and those wishing to begin participating must be wired into the new system. As new tenants come and go at the facility, the decision to be on the back-up system or not, means countless trips to the site to hook up and un-hookup the new and old tenants. This is obviously wasteful, costly and often leads multi-tenant facilities to offer no choice of backup at all.

Another issue that has come into play recently in the provision of electrical service from the electric grid is the fact that AC service may be interrupted or switched during load management operations which can happen on a routine basis. Again such operations are best suited with a power backup system to prevent interruption, even if brief, in the delivery of electrical service.

It would be useful if there were a way to selectively provide backup electrical service with one backup device to a multi-tenant facility such that when a tenant wants the backup service or wishes to be removed from back up service it can be done easily and efficiently.

### BRIEF SUMMARY OF THE INVENTION

A new method for providing backup service to a multi-tenant facility has been discovered in the present invention. The present invention provides that a device such as a meter which can be turned on and off from remote locations be provided to at least every customer that does not want to have backup service so that when the power grid is disconnected for whatever reason customers who do not want backup can be disconnected from the backup source by remote disablement of the customer meter. In one embodiment, the present invention is a system for selectively providing tenants in a multi-tenant location who are connected to an electrical normal source, an AC electrical backup when the normal source has fallen below a selected level comprising:
a) a means for providing AC backup to the multi-tenant location;
b) an automatic means for switching the multi-tenant location to and activating the backup means;
c) a means for determining which tenants are to be selected to be switched to the backup means; a remotely activatable disconnect controller for automatically disconnecting one or more non-selected tenants from the backup means; and
d) an automatic means for reconnecting the tenants back to the normal source.

In yet another embodiment, the present invention is a process for providing backup AC power to selected tenants at a multi-tenant location having a normal source connection comprising:
a) a process for transferring the AC power for the multi-tenant-location from the normal source to an engaged backup source; and
b) a process for remotely automatically disconnecting the non-selected tenants from the back-up source.

In another embodiment, there is a method for providing backup AC power to selected tenants in a multi-tenant location comprising:
a) determining if there is sufficient power for the multi-tenant location from a normal source;
b) engaging an emergency power source for the multi-tenant location when there is insufficient power from the normal source;
c) determining which tenants are not selected tenants;
d) disconnecting the non-selected tenants in a remote manner from the multi-tenant location;
e) providing emergency power to the selected tenants from the emergency power source until normal source power is returned; and
f) reconnecting the selected and non-selected tenants back to the normal source once sufficient power returns.

The above embodiments all represent a use for load management as well. During load management operations customers typically remain connected to the active power sources throughout the operation and the above embodiments should be so read as covering those embodiments as well.

It is clear from the description and drawings which follow that the embodiments herein are not intended to be limiting and the claims of this application are to be interpreted in view of that breadth.

### BRIEF DESCRIPTION OF THE DRAWINGS

FIG. 1 is a block diagram illustrating an exemplary power backup system for a multi-tenant unit.

FIGS. 2a through 2c are flowcharts illustrating the operational decision matrix of an embodiment of the present invention.

FIG. 3 is a block diagram of an embodiment where not all tenants in a multi-tenant facility are outfitted with remote disconnect means.

### DETAILED DESCRIPTION OF THE INVENTION

The present invention relates to a system for providing electrical power back up to multi-tenant units where tenant connection to the backup power can be modified from a remote location as desired.

While this invention is susceptible of embodiment in many different forms, there is shown in the drawings and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

The terms “a” or “an”, as used herein, are defined as one as or more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

As used herein “selectively providing” refers to providing backup electrical service to select customers at a given multi-tenant location. That means that all, none or part of the number of tenants at the particular location can be provided with backup service and that such service can be changed. As further disclosed herein, the ability to change those connected and those not, i.e. to remotely, selectively provide is a central embodiment of the present invention.

As used herein, the term “multi-tenant location” refers to a single structure or single group of structures to which a particular means of backup is providing service. For example, a cell tower, a multi-tenant apartment building and multi-tenant commercial buildings, such as a strip mall or multi-tenant warehouse, and the like are contemplated within the present invention. In practice these locations all have a plurality of electric meters for measuring electricity from the power grid and are all together in one general location. While this document describes a multi-tenant meter rack in a single location it in no way intends to limit the invention to a single meter location. These customers, however, will be served by the same electric utility and usually by the same transformer. They will also all be served or not by the same electrical backup means.

As used herein, AC electric backup refers to a means for providing temporary electrical service during electrical grid disconnection. Typical means would include generators, power cells, solar cells, batteries and the like. Backup systems are well known in the art and one skilled in the art could easily choose a backup system to provide appropriate electrical service to a given multi-tenant location given the number of tenants and the desired electrical load to support.

An automatic means for switching to and activating the backup means, refers to a controller, micro controller, sensor, load monitor and the like which can accomplish sensing that the grid electrical power has been disconnected, say, by a power outage or just unavailable power, such as in a brown or black out, and then use that information to turn on the power backup system and provide it to the selected tenants. Backup systems are routinely provided with such devices and they are within the skill in the art.

The present invention provides a means for remotely, automatically connecting or disconnecting an individual tenant from the backup means. That way with use of the present invention, the backup service provider can add any desired tenant to the backup system and disconnect them at anytime without the need to physically go to the meter each time. In addition by controlling the connection remotely and having the ability to disconnect, the service provider can prevent cheating or stealing of the backup services. For example, in one embodiment a remote disconnect power meter is used. A remote disconnect power meter is hooked up, one for each customer, such that people who do not wish backup service are disconnected by remotely turning off the power meter whenever the power grid is disconnected and the power meter remains connected when they have ordered or are on the backup power service. Likewise, when someone is on backup service they can simply be removed from the backup service by sending a different signal to the remote meter which automatically disconnects the remote meter when the power grid is interrupted.

In another embodiment, the disconnect means is an inline circuit which can be remotely turned on or off to interrupt electrical service through the means. The remote means can be by telephone line, cell phone signal or the like. The means can be set so that the function is set until it is changed (and not each time the power grid is interrupted), thus avoiding problems with turning the means on or off during a power grid disconnection. However, either method of interrupting the power backup is within the scope of the present invention.

In practice a number of tenants will occupy a multi-tenant unit such as a cell tower. The provider of the backup service will approach each tenant regarding backup service. Each tenant who wants the service will have a connection that remains connected to the backup source while those that deny the service will have a disconnect means in between the backup system and their electrical system that can be automatically disconnected from the backup wherein the disconnect is done remotely as described above.

In practice during a grid disconnect situation, a customer who has elected not to receive backup service can contact the backup service provider and obtain the service. The remote activation of the meter or other device allows the service provider to immediately put the customer on the backup service and provide them backup power.

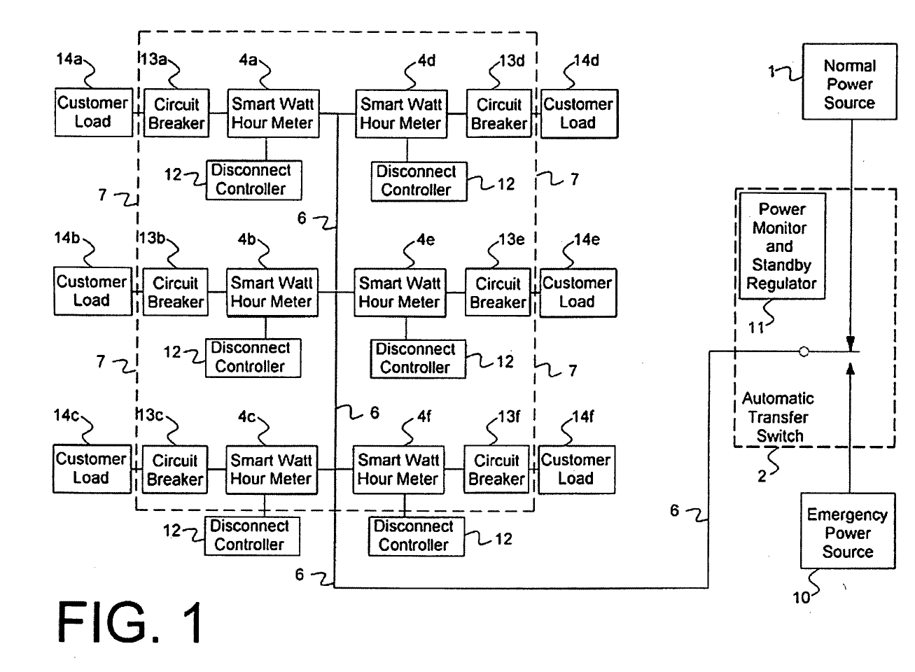

Now referring to the figures, FIG. 1 is a block diagram of an exemplar embodiment of the invention. The power company delivers electrical power over its system and creates a power grid voltage input, normal source 1 for its customers. The power provided by the normal source 1 may be disconnected intentionally by the providing utility or other entity during load management operations. In such instances, a signal is sent to the power monitor and standby regulator 11, which in this embodiment is internal to the automatic transfer switch ATS 2. The power monitor and standby regulator 11 then initiates the start sequence of the emergency power source 10. Once the power monitor and standby regulator 11 detects an acceptable level of emergency power in the ATS 2, the ATS 2 power load is transferred from the normal source 1 to the emergency source 10. In the present embodiment, the ATS load is shown as a multi-tenant unit 7. In this embodiment, the multi-tenant unit has six customers or tenants represented by their power meter as tenant meters 4a, 4b, 4c, 4d, 4e and 4f. Each of the tenant meters 4a through 4f are outfitted with an integral disconnect, which is capable of disconnecting the meter load from the common buss 6 when they receive a signal from the disconnect controller 12 triggered by an offsite remote means. This capability exists whether the emergency source or the normal source is supplying the common buss 6. During load management operations, the states of the integral disconnects will typically remain unchanged.

Backup power is represented by emergency power source 10. The emergency power source 10, as discussed above, can be batteries, a generator or any kind of backup system providing electrical standby power to the multitenant unit 7.

Once again referring to FIG. 1 but now describing the emergency operation of the system represented by FIG. 1. This normal source 1 may also be disconnected by power failure, power grid shut down, damage and the like and such event is automatically detected the power monitor and standby regulator 11 which is internal to the automatic transfer switch ATS 2. As described for intentional disconnections above, the power monitor and standby regulator 11 then initiates the start sequence of the emergency source 10. Again, once the power monitor and standby regulator 11 detects an acceptable level of emergency power in the ATS 2, the ATS 2 electrical load is transferred from the normal power source 1 to the emergency power source 10. During emergency operation, the six customers or tenants may be selectively connected or disconnected from the emergency source 10 at the discretion of the provider of the emergency source 10. This disconnection will be affected by sending a remote signal to disconnect to the disconnect controller 12 in the meter 4a to 4f of that particular customer so that the disconnect controller 12 disconnects the meter 4a to 4f, thus disconnecting the customer load from the common buss 6. The signal to disconnect may be discriminately sent to the individual meters at anytime remotely or it may have been stored in onsite equipment to initiate the disconnect sequence automatically during emergency operations. This disconnect while shown as an integrated service control switch may be performed by any suitable disconnect method.

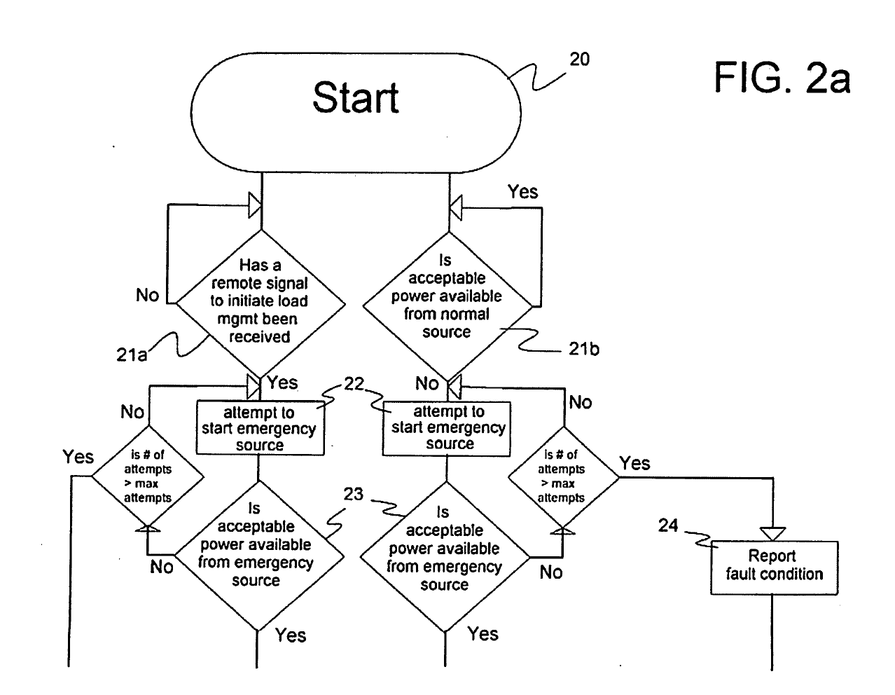

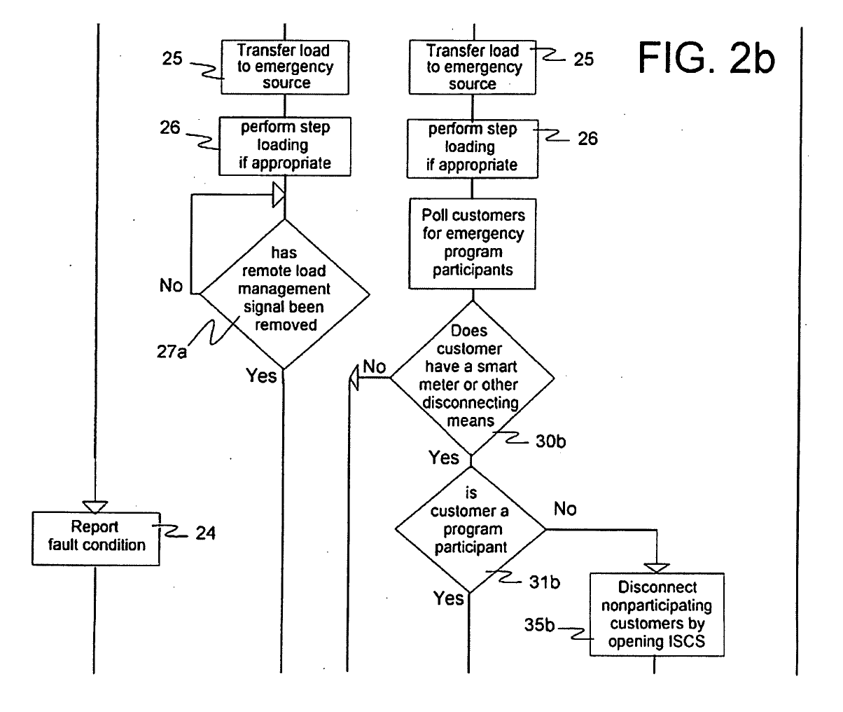

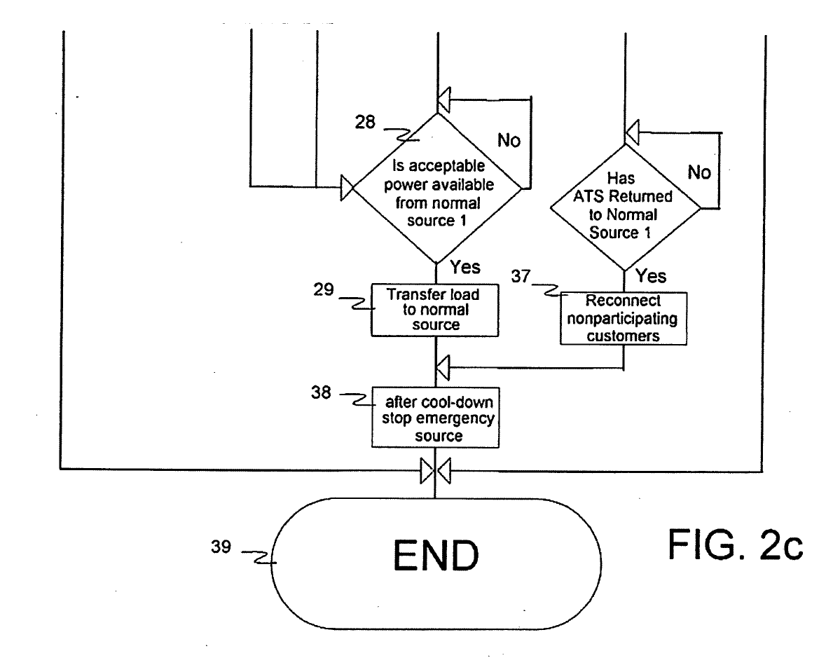

In FIGS. 2a to 2c there is a single flowchart illustrating the operational decision matrix of an embodiment of the present invention. At the start 20 the system is simultaneously determining if a signal to initiate load management operations has been received 21a and whether normal source 1 is suitable to provide power to the customers 21b. If a signal to begin load management operations has been received or if the system has determined that acceptable power is not available at the site the system will attempt to start the emergency source 22. These attempts 22 will continue until either the emergency source has acceptable power 23 and starts or the system exceeds the maximum number of attempts. If the system exceeds the maximum number of attempts, the system shuts down and sends a report fault condition 24 via the remote monitoring system. If the emergency source begins providing acceptable power the automatic transfer switch ATS 2 from FIG. 1, causes the load to be connected to the emergency source. If step loading is required and was not affected before the transfer to the emergency source the system will take steps to perform step loading at this time 26. If the system is operating in load management mode the system monitors the remote signal to determine when load management is no longer required 27a. If on the other hand the system is operating in emergency mode, the system will check to see which of the customers have smart hour meters with integrated service control switches or other disconnecting means 30b and will poll those customers 31b to see which of them are participating in the emergency backup program. The system will monitor the normal source 28 and will transfer 29 the load back to the normal source once it is available.

The non-participating customers will be disconnected 35b whenever the emergency source 10 is supplying power to the load. The system will monitor the switch position in the ATS and will reconnect the non-participating customers 37 once the switch has reconnected the load to the normal source 1. After the ATS has returned to the normal position the emergency source is shutdown 38 and the operation is ended 39.

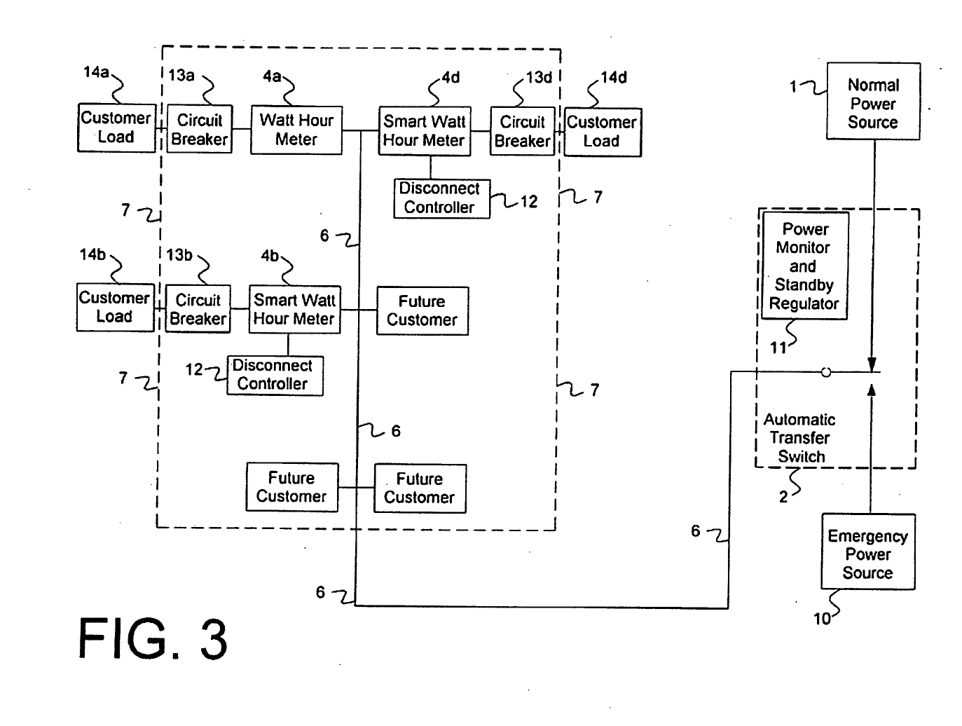

FIG. 3 is an embodiment where there are 3 tenants represented by their meters 4a, 4b and 4c. This is a portion of the block diagram shown in FIG. 1. However, in this view only tenant 4b and 4d have disconnect means 12. Therefore these customers can be added or subtracted from the circuit at any time by the remote disconnect means. Tenant 4a, however, has no disconnect means and therefore the standby power 10 of FIG. 1 cannot be disconnected and would always supply this tenant with backup power. There is no need to add the expense of a disconnect means until the first customer of a system desires a disconnect means. However, one could install them all at once to avoid the cost of repeated visits to the site to install for each customer.

The description and figures herein are capable of various substitutions of standby power disconnect means and the like within the spirit and scope of the present invention. Accordingly, the claims which follow are not to be limited by any example or the figures herein and are to be given their broadest acceptable interpretation.

Each of the tenant meters 4a through 4f are outfitted with an integral disconnect which are capable, when they receive a signal from the disconnect controller 12, to disconnect the customer load from the common buss 6 whether the emergency source or the normal source is supplying the common buss 6. The disconnect controller 12 can be as shown here controlled by feedback from the standby power 10 which determines when to disconnect a tenant. However, in other embodiments, the remote control can be independent of the activity of the disconnect means 2 or the standby power 10 as desired.

What is claimed is:

1. A system for selectively providing tenants in a multi-tenant location who are connected to an electrical normal source, an AC electrical backup source when the normal source has fallen below a selected level comprising:
a) a means for providing AC backup to the multi-tenant location;
b) an automatic means for switching the multi-tenant location to and activating the backup means;
c) a means for determining which tenants are to be selected to be switched to the backup means; a remotely activatable disconnect controller for automatically disconnecting one or more non-selected tenants from the backup means; and
d) an automatic means for reconnecting the tenants back to the normal source.

2. A system according to claim 1 wherein the remotely activatable means is a remote controlled power meter.

3. A process for providing backup AC power to selected tenants at a multi-tenant location having a normal source connection comprising:
a) a process for transferring the AC power for the multi-tenant-location from the normal source to an engaged backup source; and
b) a process for remotely automatically disconnecting the non-selected tenants from the backup source.

4. A process according to claim 3 wherein a tenant may be disconnected by remotely programming a remote controlled power meter to disconnect when the backup source is engaged.

5. A method for providing backup AC power to selected tenants in a multi-tenant location comprising:
a) determining if there is sufficient power for the multi-tenant location from a normal source;
b) engaging an emergency power source for the multi-tenant location when there is insufficient power from the normal source;
c) determining which tenants are not selected tenants;
d) disconnecting the non-selected tenants in a remote manner from the multi-tenant location;
e) providing emergency power to the selected tenants from the emergency power source until normal source power is returned; and
f) reconnecting the selected and non-selected tenants back to the normal source once sufficient power returns.

6. A method according to claim 5 wherein the non-selected tenants may be disconnected via a remote controlled power meter.
